(19) United States
(12) Patent Application Publication
(10) Pub. No.: US 2015/0362085 A1
(43) Pub. Date: Dec. 17, 2015

(54) CHECK VALVE

(71) Applicant: Q. C. WITNESS INT. CO., LTD., New Taipei City (TW)

(72) Inventors: Yuan-Lin HU, New Taipei City (TW); Yung-Tsun HUANG, New Taipei City (TW)

(21) Appl. No.: 14/306,573

(22) Filed: Jun. 17, 2014

(51) Int. Cl. F16K 15/02

(52) U.S. Cl. CPC F16K 15/026

(57) ABSTRACT

A check valve has a body, a sealing cover, a movement unit, a sealing ring, and an elastic unit. The body has a air space and multiple vents. The air space is formed in the body and has a limiting channel. The vents are formed through the body. The sealing cover is mounted on the body and has an aligning rod. The movement unit is mounted in the air space and has a mounting rod, an aligning unit and multiple air holes. The mounting rod is slidably mounted around the aligning rod. The aligning unit is connected with the mounting rod. The air holes are formed through the aligning unit. The sealing ring is mounted around the movement unit and seals the limiting channel. The elastic unit is mounted around the movement unit and abuts between the movement unit and the sealing cover.

### BACKGROUND OF THE INVENTION

1. Field of the Invention

The present invention relates to an engineering part, and more particularly to a check valve.

2. Description of Related Art

With reference to FIGS. 6 and 7, a conventional check valve 70 is mounted between a tank 80 and a compressor 90 to control the air flow between the tank 80 and the compressor 90. With reference to FIG. 7, the conventional check valve 70 has a body 71, an outlet cover 72, a movement unit 73 and an elastic unit 74. The body 70 is hollow and has a first end 711, a second end 712, and an inlet 713. The first end 711 and the second end 712 are respectively located at two ends of the body 71. The first end 711 is connected with the compressor 90 and the second end 712 is connected with the tank 80. The outlet cover 72 is mounted on the second end 712 and has an outlet hole 721 and a movement channel 722. The outlet hole 721 is formed through the outlet cover 72 and communicates with an inner space in the body 71 and the tank 80. The movement channel 722 is longitudinally formed in the outlet cover 72. The movement unit 73 is moveably mounted in the movement channel 722, selectively protrudes out of the body 71 and selectively seals the inlet 713. The elastic unit 74 is mounted around the outlet cover 72 and abuts between the outlet cover 72 and the movement unit 73.

With reference to FIGS. 6 and 8, in use, when the air pressure in the tank 80 is insufficient, the compressor 90 will supply air into the tank 80. Because the air pressure in the compressor 90 is higher than that in the tank 80, the movement unit 73 is pushed by the air pressure in the compressor 90 to move to compress the elastic unit 74 and to move toward the outlet cover 72. Then, the air from the compressor 90 enters the inlet 713 through the first end 711 and then enters the tank 80 through the outlet hole 721. When the air pressure in the tank 80 is higher than or equal to that in the compressor 90, the movement unit 73 will move toward the first end 711 and seal the inlet 713 by the force provided by the elastic unit 74, such that the air from the compressor 90 cannot enter the tank 80.

However, the conventional check valve has the following drawbacks:

1. To control the air flow, the movement unit 73 protrudes out of the body 71 after the moving process. Therefore, the components in the tank 80 may interfere with the movement unit 73. The components in the tank 80 have to be remounted away from the check valve to avoid interference with the movement unit 73.

2. The movement unit 73 moves in the movement channel 722. When an assembly tolerance occurs between the outlet cover 72 and the body 71, the movement channel 722 may be inclined relative to the movement unit 73 and the control effect of air flow may be badly affected. Furthermore, a friction loss between the movement channel 722 and the movement unit 73 may cause the movement unit 73 to swing during the moving process.

3. The body 71 is made of copper or iron. Copper has good mechanical character but high material cost and a heavy weight. Iron has a low material cost but is oxidized easily.

### SUMMARY OF THE INVENTION

The main objective of the present invention is to provide a check valve to resolve the afore-mentioned problems.

The check valve has a body, a sealing cover, a movement unit, a sealing ring, and an elastic unit.

The body is made of metal, is hollow, and has two ends and a air space longitudinally formed in the body. The air space has a limiting channel formed in a middle of the air space. The body further has a tank opening, a compressor opening and multiple vents. The tank opening is formed in one of the ends of the body and communicates with the air space. The compressor opening is formed in the other end of the body at a position opposite to the tank opening and communicates with the air space. The vents are radially formed through the body and are adjacent to the tank opening.

The sealing cover is mounted on and covers the tank opening and has an aligning rod protruding on a side of the sealing cover and located in the air space.

The movement unit is mounted in the air space and has a mounting rod, an abutting flange, an aligning unit and multiple air holes. The mounting rod is hollow, is slidably mounted around the aligning rod, and has an abutting side formed on a side of the mounting rod at a position opposite to the sealing cover. The abutting flange is annularly formed on the mounting rod. The aligning unit is hollow, is connected with the abutting side of the mounting rod, is slidably mounted in the limiting channel, and has an inlet formed through an end of the aligning unit at a position opposite to the abutting side. The air holes are radially formed through the aligning unit and communicate with an inner space of the aligning unit.

The sealing ring is mounted around the mounting rod and selectively seals the limiting channel of the air space.

The elastic unit is mounted around the aligning rod and the mounting rod and abuts between the sealing cover and the abutting flange.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a check valve in accordance with the present invention;

FIG. 2 is an exploded perspective view of the check valve in FIG. 1;

FIG. 3 is a cross sectional perspective view of the check valve in FIG. 1;

FIG. 4 is a cross sectional side view of the check valve in FIG. 1;

FIG. 5 is an operational cross sectional side view of the check valve in FIG. 1;

FIG. 6 is a side view of a conventional check valve mounted between a compressor and a tank;

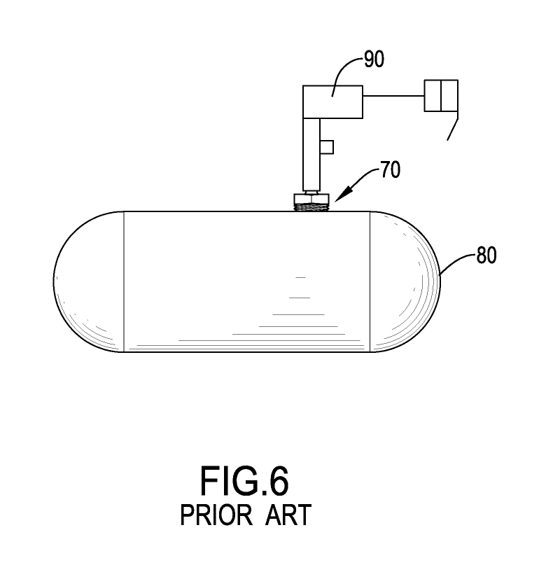

FIG. 7 is a cross sectional side of the conventional check valve; and

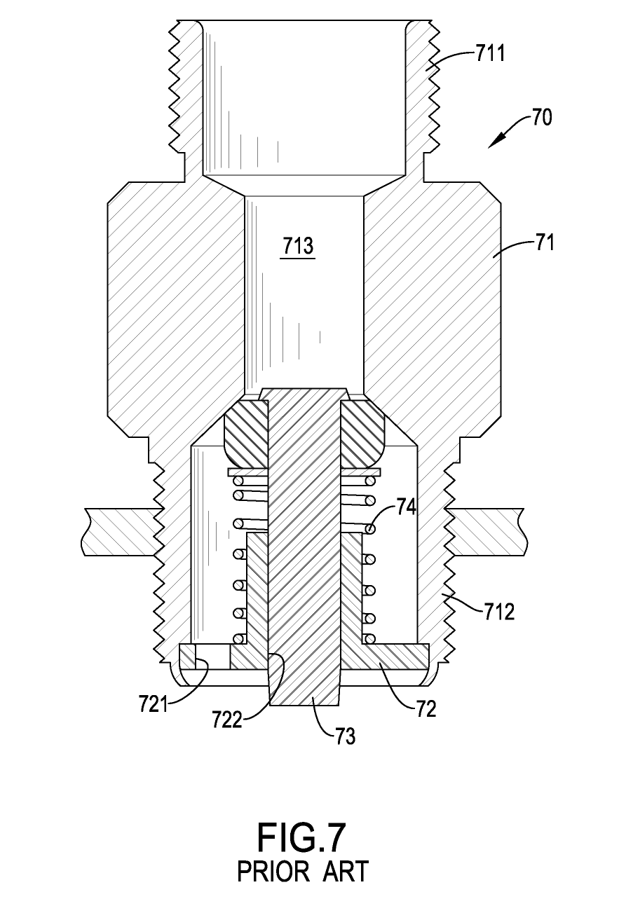

FIG. 8 is an operational cross sectional side view of the check valve in FIG. 7.

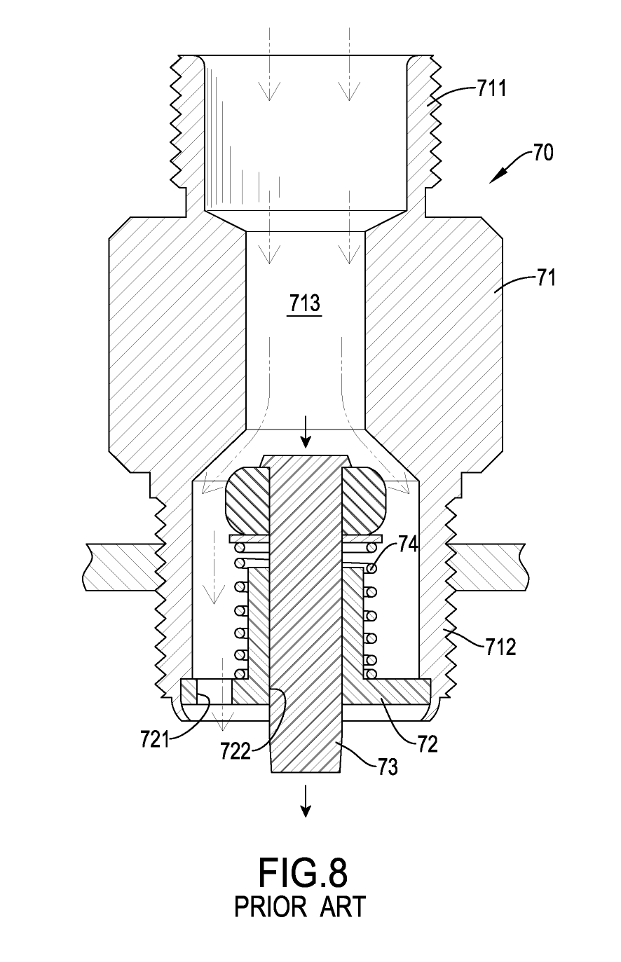

### DETAILED DESCRIPTION OF PREFERRED EMBODIMENT

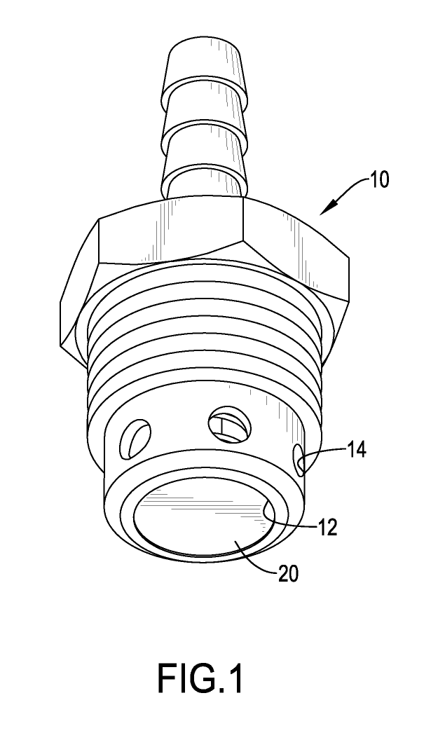

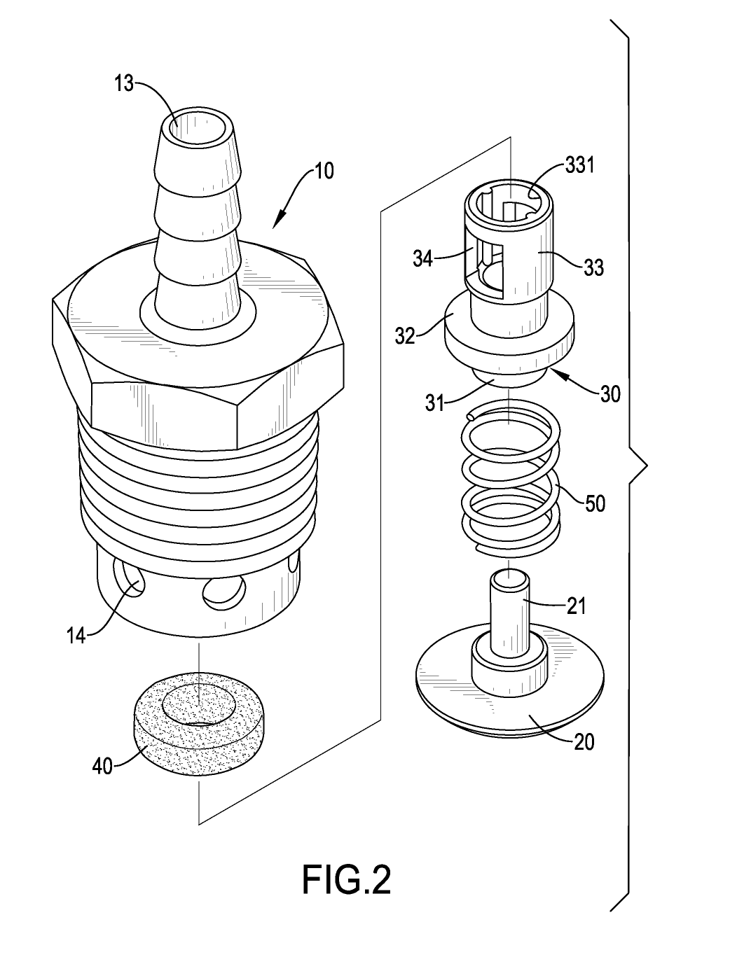

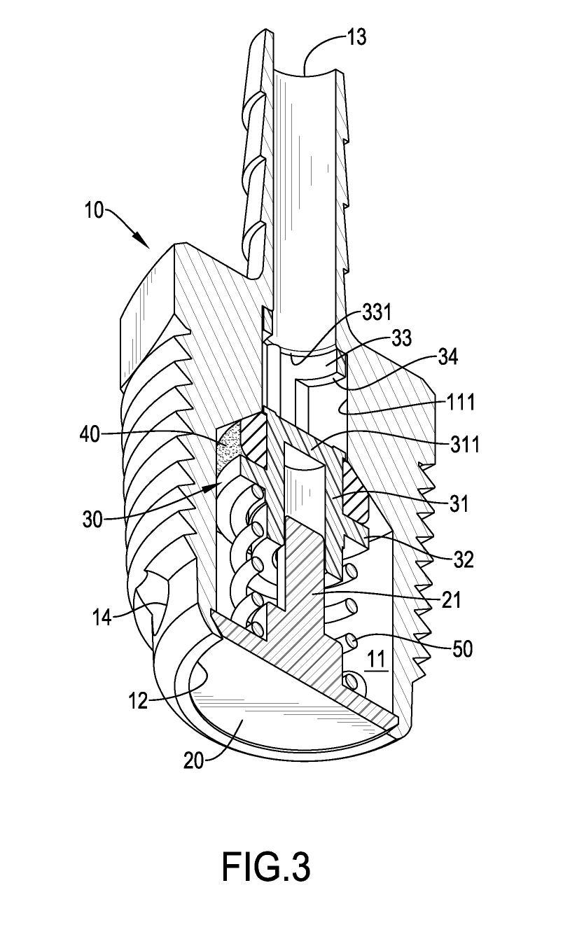

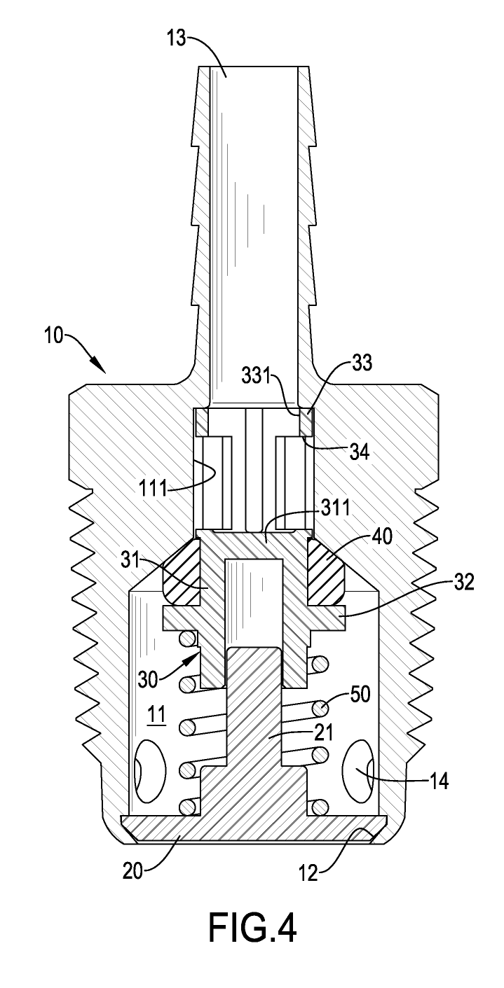

With reference to FIGS. 1 to 4, a preferred embodiment of a check valve in accordance with the present invention has a body 10, a sealing cover 20, a movement unit 30, a sealing ring 40, and an elastic unit 50.

The body 10 may be made of aluminum. Preferably, the body 10 is made of anodized aluminum, such that the body 10 has a characteristic of salt spray resistance. The body 10 is hollow and has a air space 11, a tank opening 12, a compressor opening 13 and multiple vents 14. The air space 11 is longitudinally formed in the body 10 and has a limiting channel 111. The limiting channel 111 is formed in a middle of the air space 11. The tank opening 12 and the compressor opening 13 are respectively formed in two ends of the body 10 and communicate with the air space 11. An inner diameter of the air space 11 is gradually increased from the compressor opening 13 toward the tank opening 12 of the body 10. The vents 14 are radially formed through the body 10 and are adjacent to the tank opening 12.

The sealing cover 20 is mounted on and covers the tank opening 12. The sealing cover 20 has an aligning rod 21 protruding on a side of the sealing cover 20 and located in the air space 11.

The movement unit 30 is mounted in the air space 11 and has a mounting rod 31, an abutting flange 32, an aligning unit 33 and multiple air holes 34. The mounting rod 31 is hollow and is slidably mounted around the aligning rod 21. The mounting rod 31 has an abutting side 311. The abutting side 311 is formed on a side of the mounting rod 31 at a position opposite to the sealing cover 20. The abutting flange 32 is annularly formed on an exterior of the mounting rod 31. The aligning unit 33 is hollow, is connected with the abutting side 311 of the mounting rod 31, and is slidably mounted in the limiting channel 111. A connection between the mounting rod 31 and the aligning unit 33 is closed due to the abutting side 311. The aligning unit 33 has an inlet 331 formed through an end of the aligning unit 33 at a position opposite to the abutting side 311 and communicating with an inner space of the aligning unit 33. The air holes 34 are radially formed through the aligning unit 33 and communicate with the inner space of the aligning unit 33.

The sealing ring 40 is mounted around the mounting rod 31 and selectively seals the limiting channel 111 of the air space 11. The elastic unit 50 is mounted around the aligning rod 21 and the mounting rod 31 and abuts between the sealing cover 20 and the abutting flange 32. The elastic unit 50 is located at a side of the abutting flange 32 at a position opposite to the sealing ring 40. Preferably, the elastic unit 50 is a spring.

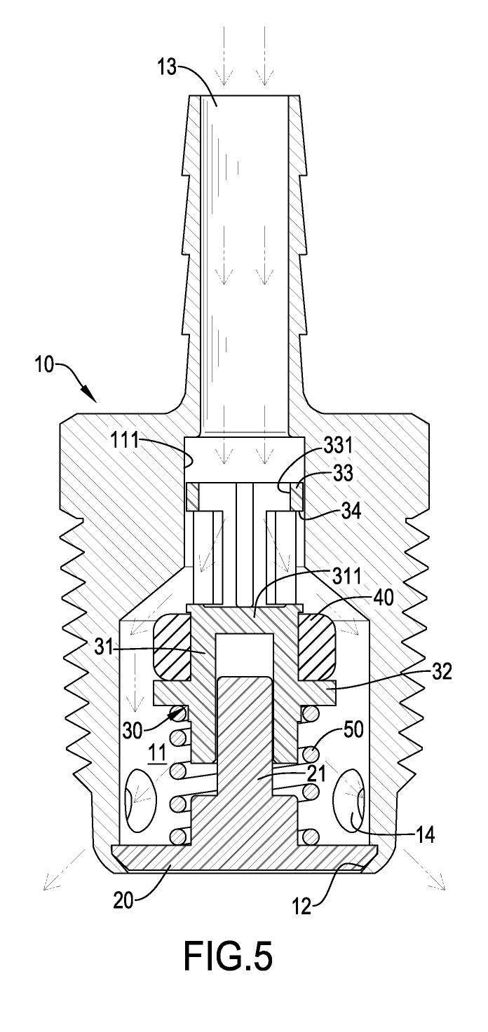

With reference to FIG. 5, in use, the body 10 is connected with a tank and a compressor via threads and hoses. The tank is connected with the tank opening 12, and the compressor is connected with the compressor opening 13. When the air pressure in the compressor is higher than the air pressure in the tank, the air pressure in the compressor will push the movement unit 30 to move toward the sealing cover 20, such that the air in the compressor can flow into the air space 11 through the compressor opening 13.

The air entering the air space 11 flows into the aligning unit 33 via the inlet 331. The air can press on the abutting side 311 since the aligning unit 33 is kept from communicating with the mounting rod 31. When the abutting side 311 is forced by the air, the movement unit 30 can be moved by the air. Then, the movement unit 30 moves toward the sealing cover 20, and the sealing ring 40 does not seal the limiting channel 111 of the air space 11. Therefore, the air can flow out from the aligning unit 33 through the air holes 34 and into the air space 11 that is adjacent to the sealing cover 20. Finally, the air flows out from the body 10 and into the tank through the vents 14 to supplement the air pressure in the tank.

When the air pressure in the tank is sufficient, the air pressure in the compressor cannot push the movement unit 30 to move. The movement unit 30 is forced by an elastic force of the elastic unit 50 and is pushed to move toward the compressor opening 31, such that the sealing ring 40 can seal the limiting channel 111 of the air space 11 again.

From the above description, it is noted that the present invention has the following advantages:

1. Resolving an interference problem: the sealing cover 20 is mounted on the tank opening 12 and the movement unit 30 is mounted around the sealing cover 20 and moves in the air space 11, so the movement unit 30 cannot protrude out of the body 10 during the moving process. Therefore, when the check valve is mounted on the tank, the components in the tank are not interfered with the check valve.

2. Stable movement of the movement unit 30. The movement unit 30 is limited for moving by two components: the aligning rod 21 and the limiting channel 111. The mounting rod 31 is mounted around the aligning rod 21, and the aligning unit 33 of the movement unit 30 moves in the limiting channel 111. The movement unit 30 can be kept from being inclined relative to the body 10 due to an assembly tolerance of the sealing cover 20 and due to a friction loss between the movement unit 30 and the aligning rod 21. Therefore, the movement unit 30 can move stably in the body 10.

3. Competitive structure characteristic: the body 10 is made of aluminum. Aluminum has advantages of both copper and iron: high resistance to oxidation, low cost, and light weight.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A check valve having:
a body made of metal, being hollow and having
two ends;
a air space longitudinally formed in the body and having a limiting channel formed in a middle of the air space;
a tank opening formed in one of the ends of the body and communicating with the air space;
a compressor opening formed in the other end of the body at a position opposite to the tank opening and communicating with the air space; and
multiple vents radially formed through the body and being adjacent to the tank opening;
a sealing cover mounted on and covering the tank opening, and the sealing cover having an aligning rod protruding on a side of the sealing cover and located in the air space;
a movement unit mounted in the air space and having
a mounting rod being hollow, slidably mounted around the aligning rod, and having an abutting side formed on a side of the mounting rod at a position opposite to the sealing cover;
an abutting flange annularly formed on the mounting rod;
an aligning unit being hollow, connected with the abutting side of the mounting rod, slidably mounted in the limiting channel, and having an inlet formed through an end of the aligning unit at a position opposite to the abutting side; and
multiple air holes radially formed through the aligning unit and communicating with an inner space of the aligning unit;
a sealing ring mounted around the mounting rod and selectively sealing the limiting channel of the air space; and
an elastic unit mounted around the aligning rod and the mounting rod and abutting between the sealing cover and the abutting flange.

2. The check valve as claimed in claim 1, wherein the elastic unit is located at a side of the abutting flange at a position opposite to the sealing ring.

3. The check valve as claimed in claim 2, wherein the elastic unit is a spring.

4. The check valve as claimed in claim 1, wherein an inner diameter of the air space is gradually increased from the compressor opening toward the tank opening of the body, and the body is made of aluminum.

5. The check valve as claimed in claim 2, wherein an inner diameter of the air space is gradually increased from the compressor opening toward the tank opening of the body, and the body is made of aluminum.

6. The check valve as claimed in claim 3, wherein an inner diameter of the air space is gradually increased from the compressor opening toward the tank opening of the body, and the body is made of aluminum.
